(19) United States
(12) Patent Application Publication
(10) Pub. No.: US 2008/0111768 A1
(43) Pub. Date: May 15, 2008

(54) PLASMA DISPLAY PANEL AND PLASMA DISPLAY DEVICE INCLUDING THE SAME

(76) Inventor: Hak-ki Choi, Suwon (KR)

Correspondence Address: CHRISTIE, PARKER & HALE, LLP, PO BOX 7068, PASADENA, CA, 91109-7068, US

(21) Appl. No.: 11/760,318

(22) Filed: Jun. 8, 2007

(30) Foreign Application Priority Data
Nov. 13, 2006 (KR) 10-2006-0111648

(51) Int. Cl. G09G 3/28

(52) U.S. Cl. 345/60

(57) ABSTRACT

A plasma display device which produces a lower amount of heat. According to an exemplary embodiment of the present invention, a plasma display device includes: a plurality of scan electrodes; a plurality of sustain electrodes, wherein the scan electrodes and the sustain electrodes form a panel capacitor; a selection circuit connected with one of the scan electrodes and for selectively applying a first voltage or a second voltage to the one of the scan electrodes; an energy recovery circuit connected with a sustain power source and the selection circuit, and for providing a sustain pulse to the one of the scan electrodes; a first driver connected with the selection circuit and for providing a rising ramp pulse to the one of the scan electrodes; and a control transistor connected between the first driver and the energy recovery circuit.

### CROSS-REFERENCE TO RELATED APPLICATION

This application claims priority to and the benefit of Korean Patent Application No. 10-2006-0111648, filed on Nov. 13, 2006, in the Korean Intellectual Property Office, the entire content of which is incorporated herein by reference.

### BACKGROUND

1. Field of the Invention

The present invention relates to a plasma display panel and a plasma display device including the same.

2. Discussion of Related Art

Scan electrodes and sustain electrodes are formed on an upper substrate of a plasma display device, and address electrodes which are perpendicular to the scan and sustain electrodes, are formed on a lower substrate of the plasma display device facing the upper substrate.

A plasma display device is driven during frames of time. One frame of the plasma display device is divided into a plurality of subfields having brightness weights. Each of the plurality of subfields includes a reset period, an address period, and a sustain period.

A wall charge is formed to stably perform a next address discharge by providing a ramp pulse to the scan electrodes during the reset period. During the address period, a scan pulse is sequentially provided to the scan electrodes, and a data pulse is provided to the address electrodes. Then, an address discharge is caused (or generated) at discharge cells to which the data pulse has been provided to form the wall charge.

During the sustain period, by alternately providing a sustain pulse to the scan electrodes and the sustain electrodes, a sustain discharge is generated in cells selected by the address discharge. Here, an image having a luminance (or brightness) corresponding to the sustain discharge time is displayed on the display panel of the display device.

A conventional plasma display device includes a scan driver for providing a driving waveform to the scan electrodes.

FIG. 1 is a circuit diagram of a scan driver of a conventional plasma display device. Referring to FIG. 1, a panel capacitor Cp is equivalent to a capacitance formed by (or between) the scan electrode Y and the sustain electrode X. Also, for the purposes of convenience, the sustain electrode X is depicted to be connected with the ground GND, but in fact, is connected with a sustain driver.

Referring to FIG. 1, the conventional scan driver includes a selection circuit 110 which is connected with each of the scan electrodes Y, the first driver 102 for providing a rising ramp pulse, the second driver 108 for providing a falling ramp pulse, the third driver 106 for providing a scan pulse, and an energy recovery circuit 104 for recovering and re-using an energy of the panel capacitor Cp.

The selection circuit 110 is connected to each of the scan electrodes Y. The selection circuit 110 selectively provides voltages of the first node N1 and the second node N2 to the scan electrode Y. That is, the selection circuit 110 controls a driving waveform (driving voltage) to be provided to the scan electrode Y by controlling the transistors Sch, Scl to be turned on or off.

During a reset period of each sub-field, the first driver 102 provides a rising ramp pulse through the selection circuit 110 to the scan electrode Y. Then, a plurality of minute discharges are generated in discharge cells, and a wall charge is generated by the minute discharges. For providing the rising ramp pulse, the first driver 102 includes a transistor Yrr, a diode Dset, and the first ramp pulse controller 103.

The second driver 108 provides a falling ramp pulse through the selection circuit 110 to the scan electrode Y after the rising ramp pulse is provided. Then, some of the wall charges formed in the discharge cells by the rising ramp pulse are removed. When some of the wall charges formed in the discharge cells are removed by the falling ramp pulse, generation of a strong discharge can be prevented. The second driver 108 includes a Zener diode Dz, a transistor Yfr, and the second ramp pulse controller 109.

The third driver 106 provides a scan pulse to the scan electrodes Y during an address period of each sub-field. For doing this, the third driver 106 includes a diode Dsch, a transistor Ysc and a capacitor Csch.

The energy recovery circuit 104 provides a sustain pulse during a sustain period of each sub-field. The energy recovery circuit 104 recovers an energy charged in the panel capacitor Cp and provides the sustain pulse using the recovered energy to reduce a power consumption when the sustain pulse is provided. The energy recovery circuit 104 includes transistors Yr, Yf, Ys and Yg, diodes D1, D2, D3 and D4, and an inductor L.

For situations where a voltage of a negative polarity is provided to the scan electrode Y, the scan driver further includes a control transistor Ypn between the first driver 102 and the second node N2 to stably maintain the voltage of the negative polarity. When the voltage of the negative polarity is provided to the scan electrode Y, the control transistor Ypn is turned off to prevent a current from flowing into the energy recovery circuit 104, such that the voltage of the negative polarity is stably provided to the scan electrode Y.

However, as shown in FIG. 2, a current flows through the control transistor Ypn when the rising ramp pulse is provided to the scan electrode Y. Here, the rising ramp pulse has a high voltage value, and a current of a correspondingly high magnitude flows into (or through) the control transistor Ypn when the rising ramp pulse is provided to the scan electrode Y. As such, a high amount of heat is generated from the control transistor Ypn. In particular, because the rising ramp pulse is provided during every sustain period, a high amount of heat is generated from the control transistor Ypn, such that an additional heat radiation measure (e.g. a large heat sink or a fan) is added to the scan driver.

### SUMMARY OF THE INVENTION

An aspect of the present invention is directed to a plasma display device which produces a lower amount of heat.

According to an exemplary embodiment of the present invention, a plasma display device includes: a plurality of scan electrodes; a plurality of sustain electrodes, wherein the scan electrodes and the sustain electrodes form a panel capacitor; a selection circuit connected with one of the scan electrodes and for selectively applying a first voltage or a second voltage to the one of the scan electrodes; an energy recovery circuit connected with a sustain power source and the selection circuit, the energy recovery circuit being adapted to provide a sustain pulse to the one of the scan electrodes; a first driver connected with the selection circuit, the first driver being adapted to provide a rising ramp pulse to the one of the scan electrodes; and a control transistor connected between the first driver and the energy recovery circuit.

The first driver may include a setup voltage source, a transistor connected between the setup voltage source and the selection circuit, a ramp pulse controller for controlling the transistor to provide the rising ramp pulse, and a diode disposed between the transistor and the setup voltage source and for preventing a reverse current.

The plasma display device may further include a second driver for providing a falling ramp pulse after the rising ramp pulse is provided and a third driver for providing a scan pulse after the falling ramp pulse is provided.

The control transistor may be configured to be turned off while the falling ramp pulse and the scan pulse are provided to the one of the scan electrodes.

The control transistor may be configured such that a current does not flow through the control transistor while the rising ramp pulse is being provided.

The energy recovery circuit may include: a source capacitor adapted to be charged with an energy recovered from the panel capacitor; a first transistor adapted to be turned on when a charged voltage of the source capacitor is provided to the panel capacitor; a second transistor adapted to be turned on when the source capacitor is charged with the energy recovered from the panel capacitor; a third transistor adapted to be turned on when a voltage of the sustain power source is provided to the panel capacitor; a fourth transistor adapted to be turned on when a ground voltage is provided to the panel capacitor; and an inductor for forming a resonant circuit with the panel capacitor.

### BRIEF DESCRIPTION OF THE DRAWINGS

These and/or other aspects and features of the present invention will become apparent and more readily appreciated from the following description of exemplary embodiments, taken in conjunction with the accompanying drawings of which:

FIG. 1 is a circuit diagram of a scan driver of a conventional plasma display device;

FIG. 2 is the circuit diagram showing the scan driver of FIG. 1, which shows a current flowing from the scan driver to a control transistor;

FIG. 3 is a block diagram of a plasma display device according to one embodiment of the present invention;

FIG. 4 is a driving waveform provided by the scan driver depicted in FIG. 3;

FIG. 5 is a circuit diagram showing a scan driver according to one embodiment of the present invention; and

FIG. 6 is the circuit diagram showing the scan driver of FIG. 5 which shows a current flowing from the scan driver to a control transistor.

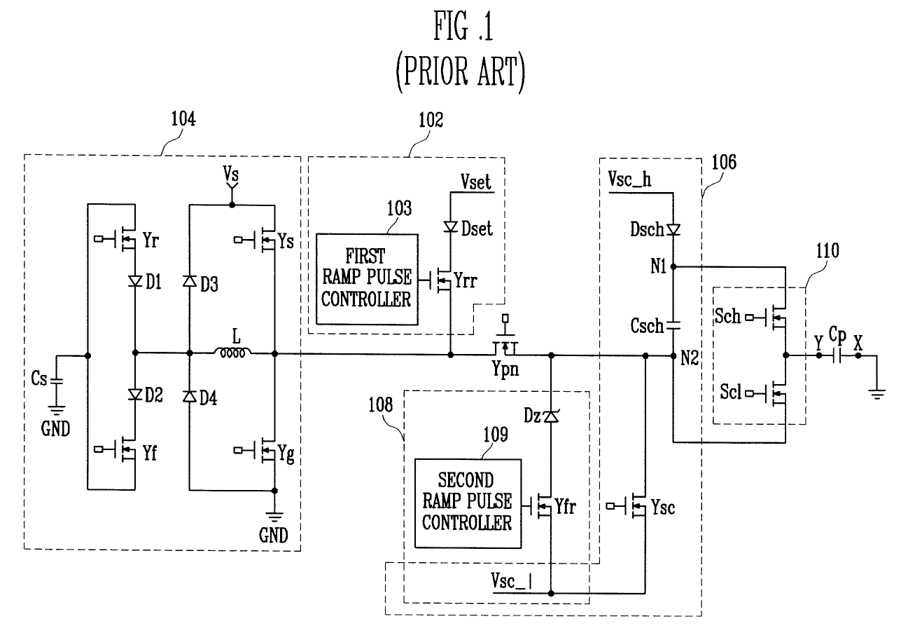

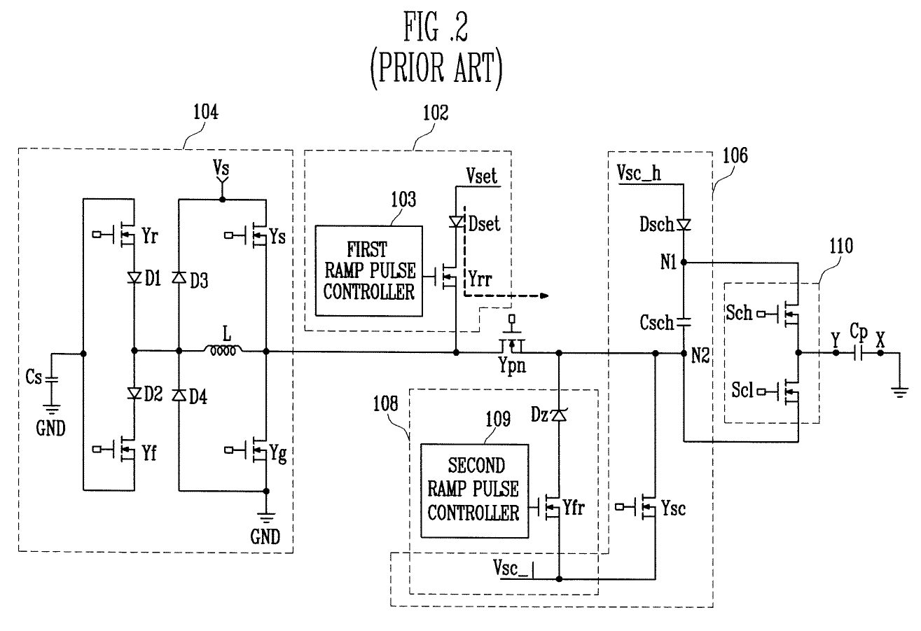

### DETAILED DESCRIPTION

Hereinafter, exemplary embodiments of the present invention will be described with reference to the accompanying drawings. Here, when a first element is described as being connected to a second element, the first element may be directly connected to the second element or may alternately be indirectly connected to the second element via a third element. Further, some of the elements that are not essential to the complete understanding of the invention are not shown to improve clarity. Also, like reference numerals refer to like elements throughout.

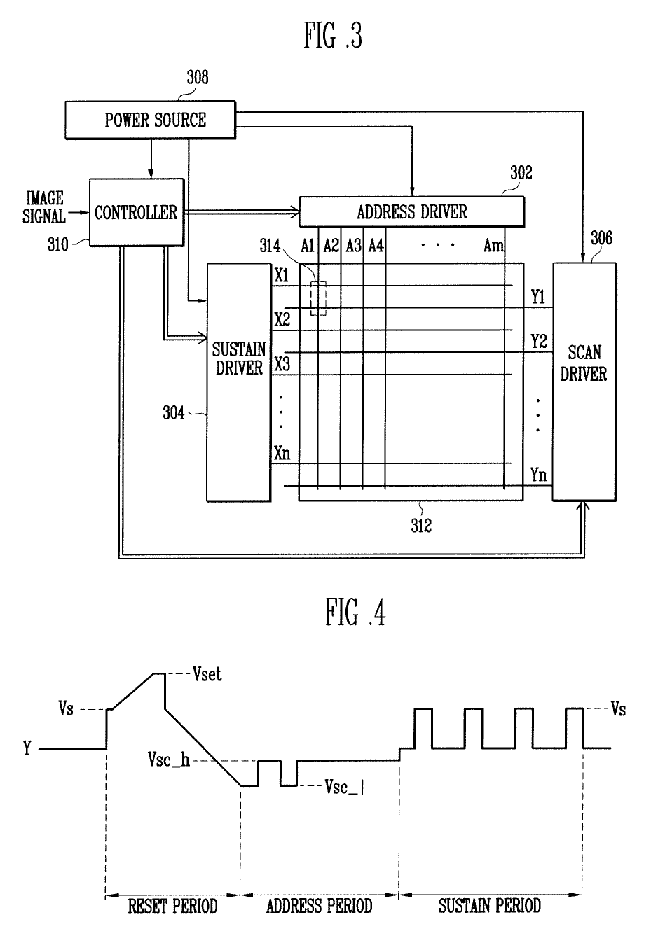

FIG. 3 is a block diagram of a plasma display device according to one embodiment of the present invention.

Referring to FIG. 3, according to the embodiment of the present invention, a plasma display device includes a display panel 312, an address driver 302, a sustain driver 304, a scan driver 306, a power source 308 and a controller 310.

The display panel 312 includes scan electrodes Y1, Y2, . . . , Yn and sustain electrodes X1, X2, . . . , Xn which are disposed to be parallel to each other, and address electrodes A1, A2, . . . , Am which are disposed to be perpendicular to the scan electrodes Y1 through Yn and the sustain electrodes X1 through Xn. Discharge cells 314 are formed at crossing regions of the scan electrodes Y1 through Yn, the sustain electrodes X1 through Xn, and the address electrodes A1 through Am. The arrangement of the scan, sustain and address electrodes Y, X, and A defining the discharge cell 314 shown in FIG. 3 is one example according to the embodiment of the present invention. However, embodiments of the present invention are not limited thereto.

The controller 310 receives an external image signal, and generates control signals for controlling the address driver 302, the sustain driver 304 and the scan driver 306. Here, the controller 310 generates the control signals to drive the plasma display device during frames of time. Each frame is divided into sub-fields which each have a reset period, an address period and a sustain period.

Corresponding to a control signal provided from the controller 310, the address driver 302 provides data pulses to the address electrodes A1 through Am during an address period of each sub-field to select discharge cells 314 to be discharged.

Corresponding to a control signal provided from the controller 310, the sustain driver 304 provides sustain pulses to the sustain electrodes X1 through Xn during the sustain period of each sub-field.

Corresponding to a control signal provided from the controller 310, the scan driver 306 controls a driving waveform provided to the scan electrodes Y1 through Yn. In other words, during the reset period of each sub-field, the scan driver 306 provides a ramp pulse to the scan electrodes Y1 through Yn, and during the address period, sequentially provides a scan pulse. Further, the scan driver 306 provides a sustain pulse to the scan electrodes Y1 through Yn. The sustain pulses provided to the scan electrodes Y1 through Yn alternate with the sustain pulses applied to the sustain electrodes X1 through Xn, during the sustain period of each sub-field.

The power source 308 provides a power needed to drive the plasma display device to the controller 310 and the drivers 302, 304 and 306.

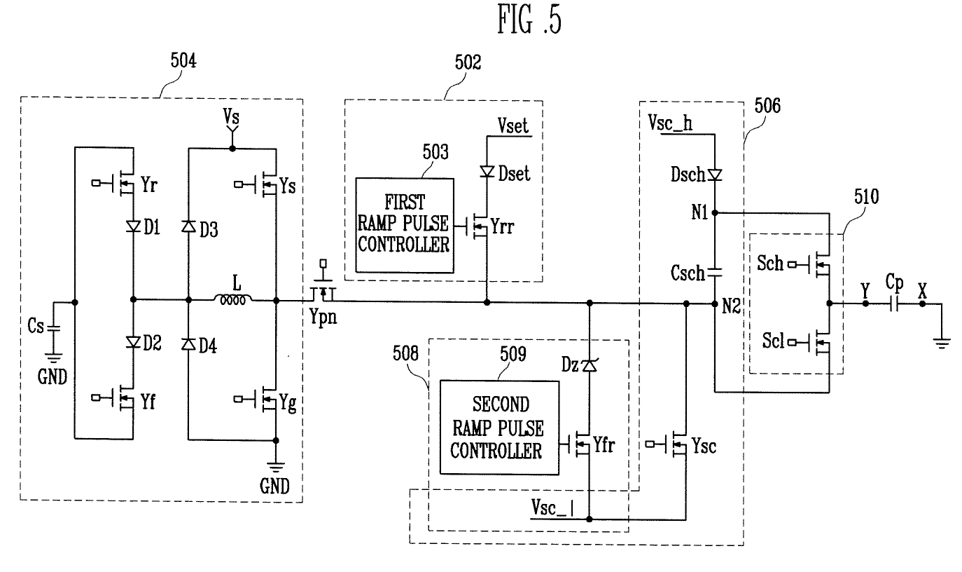

FIG. 4 shows a driving waveform provided by the scan driver 306 depicted in FIG. 3.

Referring to FIG. 4, during the reset period, the scan driver 306 provides the rising (e.g., Vs to Vset) and falling (e.g., Vs to Vsc_l) ramp pulses to the scan electrode Y. When the rising ramp pulse is provided, a plurality of minute discharges is generated in the discharge cell 314, such that wall charges are formed. When the falling ramp pulse is provided, some of the wall charges formed by the rising ramp pulse are removed. Because some of the wall charges formed in the discharge cell 314 are removed by the falling ramp pulse, a strength of a discharge in the discharge cell 314 generated during the address period may be reduced or the discharge may be prevented.

The scan driver 306 provides the scan pulse to the scan electrode Y during the address period. Here, corresponding to a gradation for displaying, the address driver 302 provides a data pulse to the address electrodes A1 through Am. Thus, by adding a voltage difference between the scan pulse and the data pulse to a wall voltage generated during the reset period (i.e. a potential difference formed on the wall of the discharge cell 314 by the wall charges), a discharge is generated in the corresponding discharge cell 314 for which the data pulse is provided. The wall charge that is needed for the sustain discharge is formed in the discharge cell 314 in which an address discharge is generated.

During the sustain period, the scan driver 306 provides a sustain pulse (or sustain pulse) to the scan electrode Y. Here, the sustain driver 304 provides the sustain pulses to the sustain electrodes alternately with the sustain pulses provided to the scan electrodes Y. Then, the wall voltage in the discharge cell 314 selected by the address discharge is added to the voltage of the sustain pulse, such that the sustain discharge is generated. Here, the length of the sustain discharge is determined according to how many times (or cycles) the sustain pulse is provided.

FIG. 5 shows a scan driver according to one embodiment of the present invention. In FIG. 5, the panel capacitor Cp is electrically equivalent to a capacitance created by (and between) the scan electrode Y and the sustain electrode X. Further, although the sustain electrode X is connected with the sustain driver 304 (see, for example, FIG. 3), for the purposes of convenience, the sustain electrode X is depicted in FIG. 5 as being connected with the ground GND. In practice, in the described embodiment, the sustain electrodes are connected with the sustain driver 304.

Referring to FIG. 5, the scan driver 306 according to the embodiment of the present invention includes a selection circuit 510 connected with each of the scan electrodes Y, the first driver 502 for proving a rising ramp pulse, the second driver 508 for providing a falling ramp pulse, the third driver 506 for providing a scan pulse, and an energy recovery circuit 504 for recovering and re-using an energy of the panel capacitor Cp.

The selection circuit 510 is connected to each scan electrode Y. The selection circuit 510 controls the transistors Sch and Scl to be turned on or off, such that one of the voltages respectively provided to a first node (or a first stage) N1 and a second node (or a second stage) N2 is selectively provided to the scan electrode Y.

The first driver 502 provides the rising ramp pulse through the selection circuit 510 to the scan electrode Y during the reset period of each sub-field. For providing the rising ramp pulse, the first driver 502 includes a transistor Yrr, a diode Dset and a first ramp pulse controller 503.

The first ramp pulse controller 503 includes a capacitor. The first ramp pulse controller 503 controls the transistor Yrr to be turned on or off, such that the capacitor is charged with a voltage and the rising ramp pulse is generated corresponding to the charged voltage.

The transistor Yrr is disposed between the second node N2 and the setup voltage source Vset, and provides the rising ramp pulse to the second node N2 according to the control of the first ramp pulse controller 503. The diode Dset is disposed (or connected) between the transistor Yrr and the setup voltage source Vset to prevent a reverse current from flowing.

After the rising ramp pulse is provided, the second driver 508 provides a falling ramp pulse through the selection circuit 510 to the scan electrode Y. For providing the falling ramp pulse, the second driver 508 includes a transistor Yfr, a Zener diode Dz and a second ramp pulse controller 509.

The second ramp pulse controller 509 controls the transistor Yfr to be turned on or off to provide the falling ramp pulse. When the falling ramp pulse is provided to the scan electrode Y, some of the wall charges formed in the discharge cell 314 by the rising ramp pulse are removed, such that a strength of a discharge generated during the address period may be reduced or the discharge may be prevented.

During the address period of each sub-field, the third driver 506 provides the scan pulse to the scan electrode Y. For providing the scan pulse, the third driver 106 includes a diode Dsch, a transistor Ysc and a capacitor Csch.

The transistor Ysc is turned on during the address period. Accordingly, the first voltage Vsc_h is provided to the first node N1, and the second voltage Vsc_l is provided to the second node N2. Here, the transistors Sch, Scl of the selection circuit 510 are alternately turned on and off such that either the first voltage Vsc_h or the second voltage Vsc_l is provided to the scan electrode Y.

In contrast, while the second driver 508 and the third driver 506 are driven to respectively provide the falling ramp pulse and the scan pulse, the control transistor Ypn is controlled to be turned off.

The energy recovery circuit 504 provides the sustain pulse during the sustain period of each sub-field. The energy recovery circuit 504 recovers the energy charged in the panel capacitor Cp and provides the sustain pulse using the recovered energy, such that the power consumption is reduced when the sustain pulse is provided. Referring to FIG. 5, the energy recovery circuit 504 includes transistors Yr, Yf, Ys, and Yg, diodes D1, D2, D3 and D4, and an inductor L.

The source capacitor Cs is charged by the energy recovered from the panel capacitor Cp during the sustain period, and returns the charged voltage to the panel capacitor Cp. As such, the source capacitor Cs has a capacitance to be charged with half of a sustain voltage Vs.

The inductor L is disposed between the source capacitor Cs and the panel capacitor Cp. Here, a resonant circuit is formed by both the inductor L and the panel capacitor Cp. Therefore, the voltage which is provided from the source capacitor Cs to the panel capacitor Cp, is increased to be about the sustain voltage Vs.

The first transistor Yr is disposed between the inductor L and the source capacitor Cs. The first transistor Yr is turned on when a voltage is provided from the source capacitor Cs to the panel capacitor Cp.

The second transistor Yf is disposed between the inductor L and the source capacitor Cs. The second transistor Yf is turned on when an energy is recovered from the panel capacitor Cp and provided to the source capacitor Cs.

The third transistor Ys is disposed between the sustain power source Vs and the panel capacitor Cp. The third transistor Ys is turned on after the recovered energy is provided from the source capacitor Cs to the panel capacitor Cp. Then, the sustain voltage Vs is provided to the panel capacitor Cp, such that the sustain discharge is stably developed.

The fourth transistor Yg is disposed between the ground GND and the panel capacitor Cp. The fourth transistor Yg is turned on when the ground voltage is provided.

The diodes D1 through D4 control the direction of current flow.

The control transistor Ypn is turned off to prevent a current from flowing through the energy recovery circuit 504 when a voltage of a negative polarity is provided to the second node N2, such that the voltage of the second node N2 may be stably maintained. The control transistor Ypn is positioned (i.e. directly connected) between the first driver 502 and the energy recovery circuit 504 such that current does not flow therethrough when the rising ramp pulse is provided to the scan electrode Y.

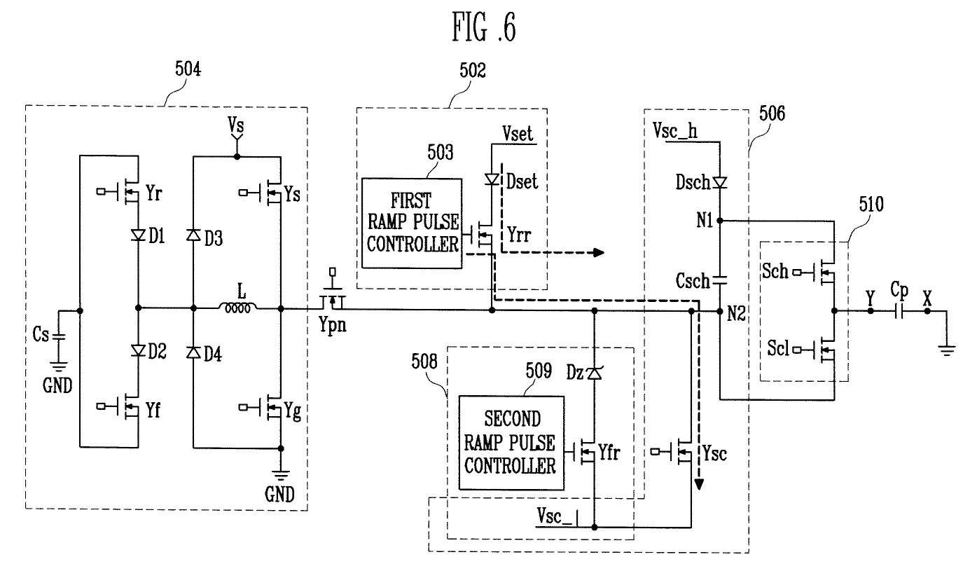

As shown in FIG. 6, the current flowing in providing the rising ramp pulse does not pass through the control transistor Ypn. Therefore, a feature of embodiments of the present invention is a minimized or reduced heat produced at the control transistor Ypn. Also, because the rising ramp pulse is provided so as not to pass through the control transistor Ypn, it is possible to prevent or reduce any distortions of the rising ramp pulse caused by an impedance of the control transistor Ypn.

Referring to FIG. 6, the capacitor of the first ramp pulse controller 503 is charged with a voltage when the transistor Ysc of the third driver 506 is turned on. For example, the capacitor of the first ramp pulse controller 503 may be charged with a voltage which is 15V higher than the second voltage Vsc_l. Since, when the capacitor of the first ramp pulse controller 503 is charged, the capacitor is charged with a voltage not passing through the control transistor Ypn, the capacitor is charged with a desirable (or certain) voltage not reduced by a loss over the control transistor Ypn.

As described above, since the rising ramp pulse is provided so as not to pass through the control transistor, heat produced at the control transistor can be minimized (or reduced). Accordingly, an additional fan is not needed in the plasma display device, thereby reducing the manufacturing cost. Furthermore, because the rising ramp pulse is provided so as not to pass through the control transistor, it is possible to prevent (or reduce) a distortion of the rising ramp pulse caused by the impedance of the control transistor.

Although a few embodiments of the present invention have been shown and described, it would be appreciated by those skilled in the art that changes might be made in the embodiments without departing from the principles and spirit of the invention, the scope of which is defined in the claims and their equivalents.

What is claimed is:

1. A plasma display device comprising:
a plurality of scan electrodes;
a plurality of sustain electrodes, wherein the scan electrodes and the sustain electrodes form a panel capacitor;
a selection circuit connected with one of the scan electrodes and for selectively applying a first voltage or a second voltage to the one of the scan electrodes;
an energy recovery circuit connected with a sustain power source and the selection circuit, the energy recovery circuit being adapted to provide a sustain pulse to the one of the scan electrodes;
a first driver connected with the selection circuit, the first driver being adapted to provide a rising ramp pulse to the one of the scan electrodes; and
a control transistor connected between the first driver and the energy recovery circuit.

2. The plasma display device as claimed in claim 1, wherein the first driver comprises:
a setup voltage source;
a transistor connected between the setup voltage source and the selection circuit;
a ramp pulse controller for controlling the transistor to provide the rising ramp pulse; and
a diode disposed between the transistor and the setup voltage source and for preventing a reverse current.

3. The plasma display device as claimed in claim 1, further comprising:
a second driver for providing a falling ramp pulse after the rising ramp pulse is provided; and
a third driver for providing a scan pulse after the falling ramp pulse is provided.

4. The plasma display device as claimed in claim 3, wherein the control transistor is configured to be turned off while the falling ramp pulse and the scan pulse are provided to the one of the scan electrodes.

5. The plasma display device as claimed in claim 1, wherein the control transistor is configured such that a current does not flow through the control transistor while the rising ramp pulse is being provided.

6. The plasma display device as claimed in claim 1, wherein the energy recovery circuit comprises:
a source capacitor adapted to be charged with an energy recovered from the panel capacitor;
a first transistor adapted to be turned on when a charged voltage of the source capacitor is provided to the panel capacitor;
a second transistor adapted to be turned on when the source capacitor is charged with the energy recovered from the panel capacitor;
a third transistor adapted to be turned on when a voltage of the sustain power source is provided to the panel capacitor;
a fourth transistor adapted to be turned on when a ground voltage is provided to the panel capacitor; and
an inductor for forming a resonant circuit with the panel capacitor.

7. The plasma display device as claimed in claim 1, wherein the selection circuit comprises:
a first transistor having a first terminal and a second terminal; and
a second transistor having a first terminal and a second terminal,
wherein the second terminal of the first transistor and the first terminal of the second transistor are connected to the one of the scan electrodes,
wherein the first terminal of the first transistor is adapted to receive the first voltage, and
wherein the second terminal of the second transistor is adapted to receive the second voltage.

8. A plasma display device adapted to be driven during a plurality of frames, each of the frames including a plurality of subfields and each of the subfields including a reset period, an address period following the reset period, and a sustain period following the address period, the plasma display device comprising:
a plurality of scan electrodes and a plurality of sustain electrodes, the scan electrodes and the sustain electrodes forming a panel capacitor therebetween;
a control transistor comprising a first terminal and a second terminal;
a selection circuit coupled with one of the scan electrodes and adapted to apply a first voltage or a second voltage to the one of the scan electrodes;
a sustain voltage source;
an energy recovery circuit coupled with the sustain voltage source and the first terminal of the control transistor and adapted to provide a sustain pulse to the one of the scan electrodes via the control transistor during the sustain period of one of the subfields; and
a first driver coupled with the second terminal of the control transistor and adapted to provide a rising ramp pulse to the one of the scan electrodes during the reset period of the one of the subfields.

9. The plasma display device of claim 8, wherein the first driver comprises:
a setup voltage source;
a transistor connected between the setup voltage source and the second terminal of the control transistor;
a ramp pulse controller adapted to control the transistor to provide the rising ramp pulse; and
a diode having terminals respectively coupled to the transistor and the setup voltage source.

10. The plasma display panel of claim 8, further comprising:
a second driver adapted to provide a falling ramp pulse to the one of the scan electrodes during the reset period of the one of the subfields, the providing of the falling ramp pulse following the providing of the rising ramp pulse; and
a third driver adapted to provide a scan pulse to the one of the scan electrodes during the address period of the one of the subfields.

11. The plasma display device of claim 8, wherein the control transistor is configured to be turned off during the reset period and the address period of the one of the subfields.

12. The plasma display device of claim 11, where the control transistor is configured to be turned on during the sustain period of the one of the subfields.

13. The plasma display device of claim 8, wherein the energy recovery circuit comprises:
a source capacitor adapted to be charged with an energy recovered from the panel capacitor;
a first transistor adapted to be turned on such that a charged voltage of the source capacitor is provided to the panel capacitor;
a second transistor adapted to be turned on such that the source capacitor is charged with the energy recovered from the panel capacitor;
a third transistor adapted to be turned on such that a voltage of the sustain voltage source is provided to the panel capacitor;
a fourth transistor adapted to be turned on such that a ground voltage is provided to the panel capacitor; and
an inductor adapted to form a resonant circuit with the panel capacitor.

14. The plasma display device of claim 8, wherein the selection circuit comprises:
a first transistor having a first terminal and a second terminal; and
a second transistor having a first terminal and a second terminal,
wherein the second terminal of the first transistor and the first terminal of the second transistor are connected to the one of the scan electrodes,
wherein the first terminal of the first transistor is adapted to receive the first voltage, and
wherein the second terminal of the second transistor is adapted to receive the second voltage.

15. A driving circuit of a plasma display panel comprising a plurality of scan electrodes and a plurality of sustain electrodes, the driving circuit comprising:
a selection circuit connected with one of the scan electrodes and for selectively applying a first voltage or a second voltage to the one of the scan electrodes;
an energy recovery circuit connected with a sustain power source and the selection circuit, and for providing a sustain pulse to the one of the scan electrodes;
a first driver connected with the selection circuit and for providing a rising ramp pulse to the one of the scan electrodes; and
a control transistor connected between the first driver and the energy recovery circuit.
